(19) United States
(12) Patent Application Publication
(10) Pub. No.: US 2011/0055847 A1
(43) Pub. Date: Mar. 3, 2011

(54) PROCESS MANAGEMENT SYSTEM AND METHOD

(75) Inventor: JYH-GWO JU, Tu-Cheng (TW)

(73) Assignee: HON HAI PRECISION INDUSTRY CO., LTD., Tu-Cheng (TW)

(21) Appl. No.: 12/622,607

(22) Filed: Nov. 20, 2009

(30) Foreign Application Priority Data
Aug. 26, 2009 (CN) 200910306108.2

(51) Int. Cl. G06F 9/54; G06F 3/048

(52) U.S. Cl. 719/313; 715/804

(57) ABSTRACT

A process management system includes a display, a process management module and a plurality of window process modules. The window process modules communicate with the process management module. Each window process module processes one function on the display. Each window process module includes a process handshake message interface for communicating with the process management module according to a message. The process handshake message interface includes a pipe file descriptor sub-module, a source identification sub-module and an option sub-module. The pipe file descriptor sub-module defines a pipe target of the window process module in the message. The source identification sub-module indicates a source of the message. The option sub-module defines an execution value in the message. The process management module sends the message to the window process module through the process handshake message interface. The window process module receives the message and executes a command according to the execution value.

### BACKGROUND

1. Technical Field

The present disclosure relates to a process management system and a process management method.

2. Description of Related Art

Embedded devices, for example, digital photo frames (DPFs), are becoming increasingly popular due to their convenience and ease of manipulation when implementing particular functions. However, if the embedded device provides only one window application, all active UI-based functions (for example, video, photo) must be integrated therein. Every time a window function (for example, browsing photos) is needed, the window application plus all other accompanying window functions must be implemented, needlessly consuming system resources. If the window application is divided into a plurality of window modules, a communication interface thereamong is further required.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a process management system as disclosed.

FIG. 2 is a flowchart of a handshake start and stop of a process management method as disclosed.

FIG. 3 is a flowchart of a process query status of the method of FIG. 2.

FIG. 4 is a flowchart of a process termination of the method of FIG. 2.

FIG. 5 is a flowchart of a process management module of the system of FIG. 1 broadcasting a message.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

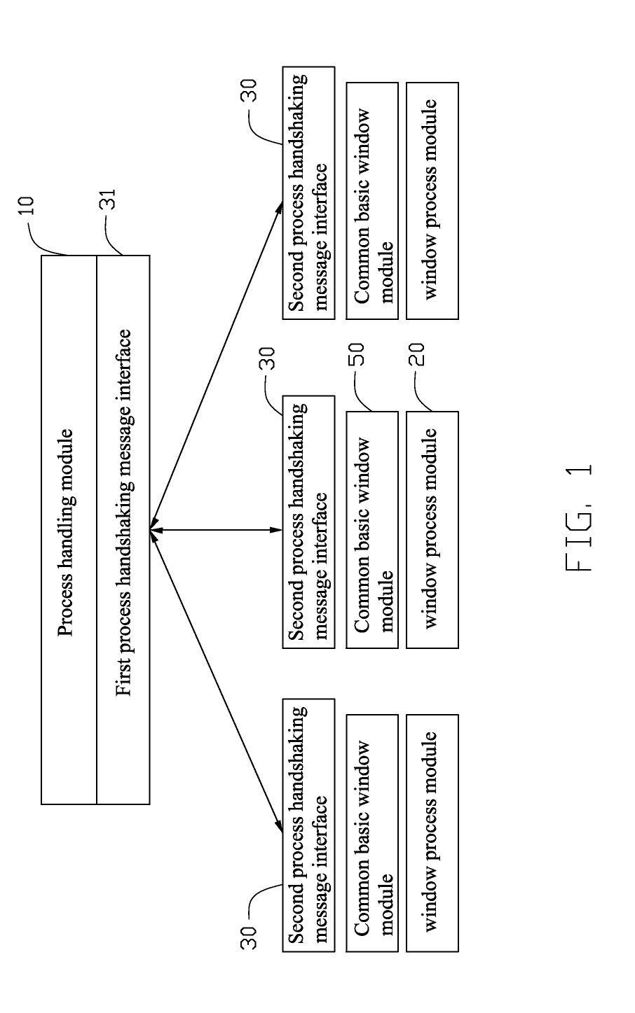

Referring to FIG. 1, a process management system includes a process management module 10, a plurality of window process modules 20, and a display showing each window process module 20. The process management module 10 includes a first process handshake message interface 31 to communicate with the window process module 20 based on a unified standardized protocol. The process management module 10 includes a detection sub-module capable of detecting and managing a message from the window process module 20.

The window process module 20 communicates with the process management module 10 through a second process handshake message interface 30 and a common basic window module 50. The common basic window module 20 provides a common basic function for the window process module 20. The window process module 20 may be a video window module, a photo window module, or a radio window module. The window process module 20 includes a managing sub-module capable of detecting and managing the message from the process management module 10.

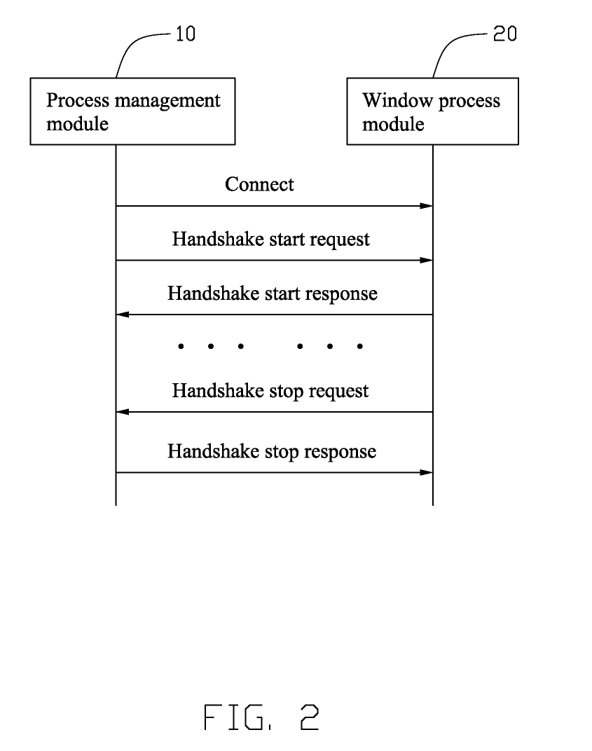

Referring to FIG. 2, the first or second process handshake message interface 30, 31 includes a pipe file descriptor sub-module, a source identification sub-module, an option sub-module, and a data sub-module. The pipe file descriptor sub-module indicates a pipe connecting the window process module 20 with the process management module 10. The source identification sub-module locates the origin of the message. The option sub-module indicates a process option to describe actions of the window process module 20 and the process management module 10. The data sub-module indicates information of the window process module 20.

The pipe file descriptor sub-module, the source identification sub-module, and the option sub-module include values defined as 4-octet integers. The data sub-module includes values defined as 20-octet strings. The option sub-module defines an execution value comprising one command action indicating response ok, handshake start, handshake stop, query status, broadcast message, process terminate, handshake start response, handshake stop response, process terminate response, broadcast message response, or query status response. The execution value and the command are defined as follows.

| execution value | command |
|---|---|
| 0x00000000 | Response ok |
| 0x00000001 | Handshake start |
| 0x00000002 | Handshake stop |
| 0x00000003 | Query status |
| 0x00000004 | Process terminate |
| 0x00000005 | Broadcast message |
| 0x00000011 | Handshake start response |
| 0x00000012 | Handshake stop response |
| 0x00000013 | Query status response |
| 0x00000014 | Process terminate response |
| 0x00000015 | Broadcast message response |

The window process module 20 communicates with the process management module 10 through an underlying Transfer Control Protocol/Internet Protocol (TCP/IP) network connection or a pipe. The process management module 10 sends a handshake start (0x00000000) request to the window process module 20. Then the window process module 20 sends a handshake start response (0x00000011) to the process management module 10. The window process module 20 sends a handshake stop (0x00000002) request to the process management module 10. The process management module 10 sends a handshake stop response (0x00000012) to the window process module 10.

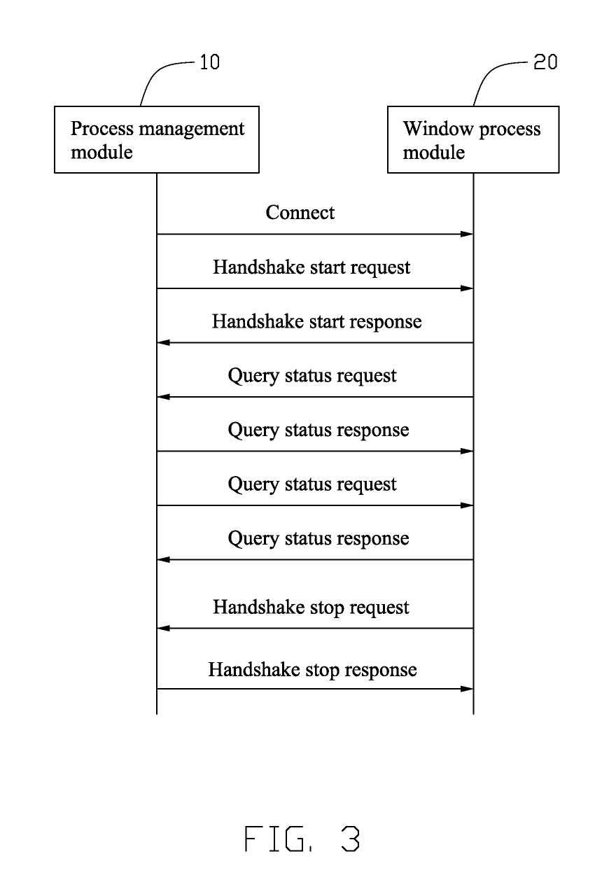

Referring to FIG. 3, the window process module 20 sends a query status (0x00000003) request to the process management module 10 to query operating status. The process management module 10 sends a query status response (0x00000013) to the window process module 20. The process management module 10 further sends a query status (0x00000003) request to the window process module 20 to query operating status. The window process module 20 sends a query status response (0x00000013) to the process management module 10.

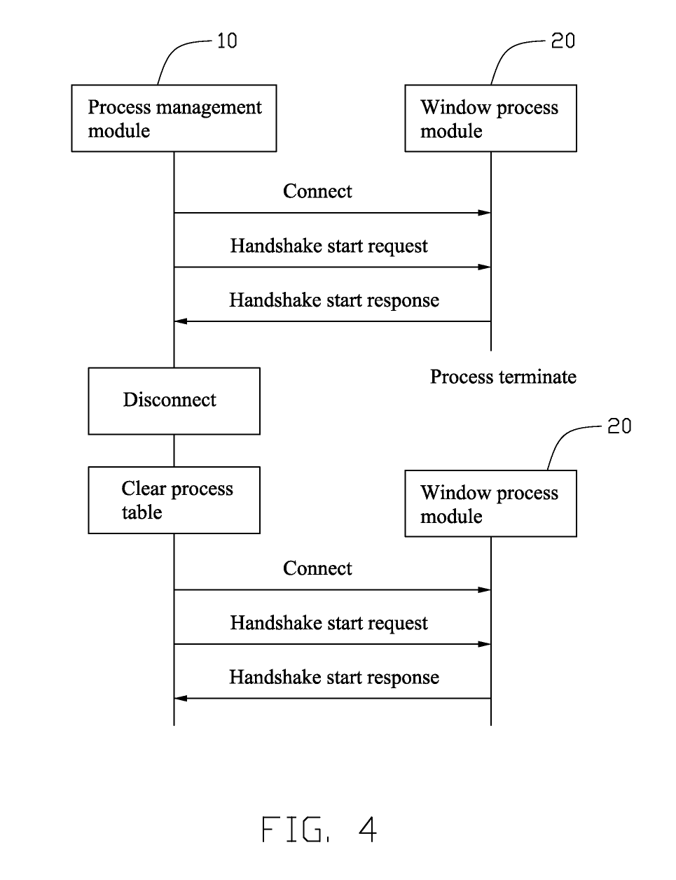

Referring to FIG. 4, the window process module 20 terminates after the window process module 20 connects to the process management module 10. The process management module 10 receives a process terminate (0x00000004) signal from the window process module 20. The process management module 10 deletes the name of the window process module 20 from a process table in the process management system, and then establishes a connection with another window process module 20.

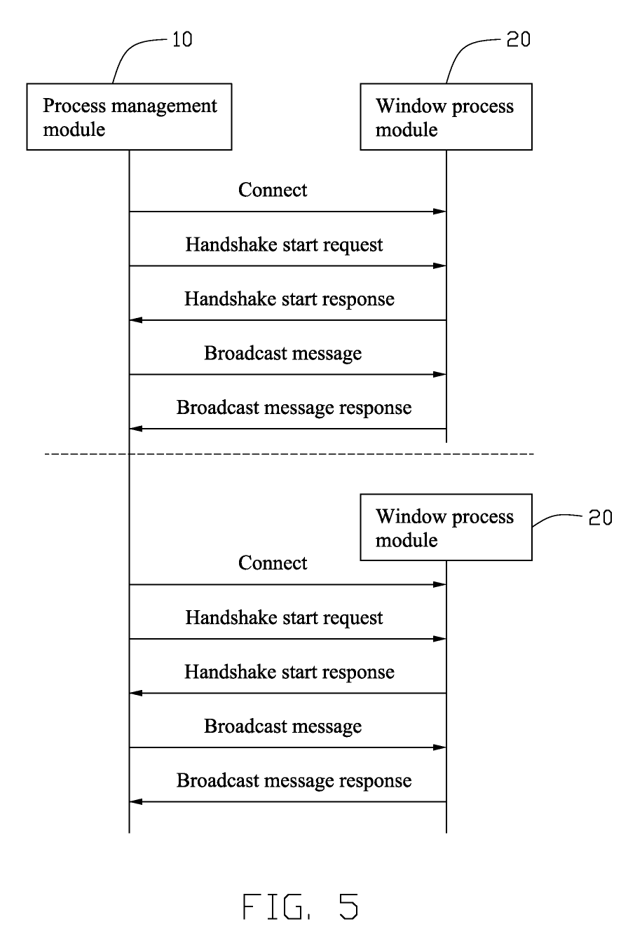

Referring to FIG. 5, the process management module 10 sends a broadcast message (0x00000005) to more than one window process module 20. Each window process module 20 sends a broadcast message response (0x00000015) to the process management module 10 to notify the process management module 10 if the broadcast message is received. At least two window process modules 20 may directly communicate through the second process handshake message interface 30.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A process management system, comprising:
a display;
a process management module; and
a plurality of window process modules communicating with the process management module, each window process module capable of processing one function on the display; each window process module comprising a process handshake message interface for communicating with the process management module according to a message, the process handshake message interface comprising:
a pipe file descriptor sub-module capable of defining a pipe target of the window process module in the message;
a source identification sub-module capable of indicating a source of the message; and
an option sub-module capable of defining an execution value in the message;
wherein the process management module is capable of sending the message to the window process module through the process handshake message interface, and the window process module is capable of receiving the message and executing a command according to the execution value.

2. The process management system of claim 1, wherein the execution value expresses one of command actions indicating handshake start and handshake stop.

3. The process management system of claim 1, wherein the pipe file descriptor sub-module, the source identification sub-module and the option sub-module comprise values defined in four-octet integers.

4. The process management system of claim 1, wherein the process management module is capable of sending broadcast messages to more than one window process module through the process handshake message interface.

5. The process management system of claim 1, wherein the execution value expresses one of command actions selected from a group consisting of handshake start response, handshake stop response, process terminate response, broadcast message response, and query status response.

6. The process management system of claim 1, wherein the process management module comprises a detection sub-module capable of detecting the message from the window process module.

7. The process management system of claim 1, wherein the window process module comprises a managing sub-module capable of managing the message from the process management module.

8. The process management system of claim 1, wherein the process handshake message interface comprises a data sub-module capable of indicating additional information of the window process module.

9. The process management system of claim 1, wherein the window process module communicates with the process management module through a Transmission Control Protocol/Internet Protocol.

10. The process management system of claim 1, wherein at least two window process modules are capable of communicating via the process handshake message interface.

11. A process management system, comprising:
a display;
a process management module; and
a plurality of window process modules communicating with the process management module through a Transmission Control Protocol/Internet Protocol, each window process module capable of processing one function on the display; each window process module comprising a process handshake message interface for communicating with the process management module according to a message, the process handshake message interface comprising:
a source identification sub-module capable of indicating a source of the message;
an option sub-module capable of defining an execution value in the message;
wherein the process management module is capable of sending the message to the window process module through the process handshake message interface, and the window process module is capable of receiving the message and executing a command according to the execution value.

12. The process management system of claim 11, wherein the execution value expresses one of command actions indicating handshake start and handshake stop.

13. The process management system of claim 11, wherein the process handshake message interface further comprises a pipe file descriptor sub-module capable of defining a pipe target of the window process module in the message.

14. The process management system of claim 13, wherein the pipe file descriptor sub-module, the source identification sub-module and the option sub-module comprise values defined as 4-octet integers.

15. The process management system of claim 11, wherein the process management module is capable of broadcasting messages to more than one window process module through the process handshake message interface.

16. The process management system of claim 11, wherein the execution value expresses one of command actions selected from a group consisting of handshake start response, handshake stop response, process terminate response, broadcast message response, and query status response.

17. The process management system of claim 11, wherein the process management module comprises a detection sub-module capable of detecting the message from the window process module.

18. The process management system of claim 11, wherein the window process module comprises a managing sub-module capable of managing the message from the process management module.

19. The process management system of claim 11, wherein the process handshake message interface comprises a data sub-module capable of indicating additional information of the window process module.

20. The process management system of claim 11, wherein at least two window process modules are capable of communicating via the process handshake message interface.
